(19) United States
(12) Patent Application Publication
(10) Pub. No.: US 2024/0340560 A1
(43) Pub. Date: Oct. 10, 2024

(54) Hybrid Point-to-point And Point-to-multipoint Network

(71) Applicant: DZS Inc., Plano, TX (US)

(72) Inventors: Seung Dong Lee, Plano, TX (US); Keith Nauman, St. Petersburg, FL (US); Kenneth Kerpez, Plano, TX (US)

(21) Appl. No.: 18/316,926

(22) Filed: May 12, 2023

Related U.S. Application Data
(60) Provisional application No. 63/494,264, filed on Apr. 5, 2023.

(51) Int. Cl. H04Q 11/00; H04J 3/16; H04J 14/02

(52) U.S. Cl. CPC H04Q 11/0067; H04J 3/1694; H04J 14/0282

(57) ABSTRACT

According to one example, a system includes: a point-to-multipoint (P2MP) module providing a P2MP connection to at least one coexistence element of a network; a point-to-point (P2P) module providing a P2P connection to a coexistence element, wherein the system is configured to receive data over the P2MP connection and transmit data over the P2P connection.

### PRIORITY INFORMATION

This application claims the priority of U.S. Provisional Application Ser. No. 63/494,264, filed Apr. 5, 2023, entitled “Network Machine”, the entire disclosure of which is incorporated herein by reference.

### BACKGROUND

Various approaches may be used to design optical networks. Passive optical networking (PON) and active optical networking (AON) are two different approaches to building fiber-optic networks.

PON is a network architecture that uses passive optical components, such as splitters and couplers, to distribute the signal from a central location to multiple users. In PON, the optical signals travel through the fiber from the central office to the user's premises without any active electronics. The signal is split into multiple streams using passive components, and each stream is sent to a different user. The downstream signals from the central office are broadcast to all users, and each user receives only the signal intended for them. The upstream signals from the user's premises are combined and sent back to the central office.

AON, on the other hand, is a network architecture that uses active electronics, such as switches and routers, to manage and distribute the signal. In AON, the optical signal from the central office is converted to an electrical signal using an optical-electrical converter, and then it is processed and managed by active electronics, which determine the routing and switching of the signal. AON can provide greater flexibility in terms of bandwidth allocation and network management, but it requires more complex and expensive equipment than PON.

It is desirable to design optical networks, particularly passive optical networks, that can maximize the bandwidth of both upload and download speeds to end users.

### SUMMARY

According to one example, a system includes a point-to-multipoint (P2MP) module providing a P2MP connection to at least one coexistence element of a network. A point-to-point (P2P) module provides a P2P connection to a coexistence element. The system is configured to receive data over the P2MP connection and transmit data over the P2P connection.

According to one example, a network includes an optical line terminal OLT that includes a point-to-multipoint (P2MP) module and a point-to-point (P2P) module. The network further includes a coexistence element in communication with both the P2MP module and the P2P module. The network further includes a splitter in communication with the coexistence element and a plurality of optical network terminals (ONTs) in communication with the splitter. The OLT is configured to transmit data to the ONTs using the P2P module using a P2P protocol. The OLT is configured to receive data from the ONTs using the P2MP module using a P2MP protocol.

According to one example, a method includes, with a point-to-multipoint (P2MP) module, receiving data from one of a plurality of optical network terminals (ONTs) using a P2MP protocol, the data being received through a coexistence element of a passive optical network. The method further includes, with a point-to-point (P2P) module transmitting data to the one of the plurality of ONTs through the coexistence element using a P2P protocol.

### BRIEF DESCRIPTION OF THE DRAWINGS

Aspects of the present disclosure are best understood from the following detailed description when read with the accompanying figures.

FIG. 1A is a diagram showing an illustrative hybrid point-to-point and point-to-multipoint network, according to one example of principles described herein.

FIG. 1B is a diagram showing download traffic over the hybrid network, according to one example of principles described herein.

FIGS. 1C and 1D are diagrams showing upload traffic over the hybrid network, according to one example of principles described herein.

FIG. 2A is a diagram showing additional features of an illustrative hybrid point-to-point and point-to-multipoint network, according to one example of principles described herein.

FIG. 2B is a diagram showing the flow of data in an illustrative hybrid point-to-point and point-to-multipoint network, according to one example of principles described herein.

FIG. 3 is a flowchart showing an illustrative method for operating a hybrid point-to-point and point-to-multipoint network, according to principles described herein.

FIG. 4 is a diagram showing an illustrative computing system that may be used to perform processes related to operating a hybrid point-to-point and point-to-multipoint network, according to one example of principles described herein.

In the figures, elements having similar designations may or may not have the same or similar functions.

### DETAILED DESCRIPTION

In the following description, specific details are set forth describing some examples consistent with the present disclosure. It will be apparent, however, to one skilled in the art that some examples may be practiced without some or all of these specific details. The specific examples disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one example may be incorporated into other examples unless specifically described otherwise or if the one or more features would make an example non-functional.

Point-to-multipoint (P2MP) protocol is a communication protocol used in computer networking to establish a connection between a single sender and multiple receivers. It enables data transmission from one point to multiple destinations simultaneously without the need for multiple point-to-point (P2P) connections. P2MP is often used for video conferencing and streaming applications, where a single source transmits video or audio to multiple destinations simultaneously. The P2MP protocol may use different transmission media such as Ethernet, Asynchronous Transfer Mode (ATM), Multi-Path Label Switching (MPLS), multicast, wireless, and optical networks.

In the context of optical networking, P2MP utilizes a communication architecture that allows a single optical signal to be transmitted from a source to multiple destinations, over a single fiber-optic cable. In an optical P2MP network, a central optical line terminal (OLT) is used to transmit the data over the fiber-optic cable to multiple optical network units (ONUs) or optical network terminals (ONTs) located at the destination sites. The OLT acts as the central hub, while the ONUs/ONTs are the endpoints that receive the data.

To enable P2MP communication over a fiber-optic network, one technique that may be used is called wavelength division multiplexing (WDM). WDM allows multiple optical signals, each at a different wavelength, to be transmitted over a single fiber. The OLT uses WDM to transmit multiple optical signals, each at a different wavelength, to the ONUs/ONTs located at different destinations.

The ONUs/ONTs may then demultiplex the received signals by wavelength to extract the data intended for them, while ignoring the signals intended for other destinations. This enables a single optical fiber to be shared among multiple users, improving network efficiency and reducing deployment costs.

Optical P2MP networks are commonly used in applications such as fiber-to-the-home (FTTH) and fiber-to-the-building (FTTB) networks, where a single fiber-optic cable is used to connect a central office to multiple homes or buildings. Overall, optical P2MP networks provide a cost-effective and efficient way to transmit data to multiple destinations over a single fiber-optic cable, without requiring separate fibers for each destination.

Optical P2MP networks often transmit across an Optical Distribution Network (ODN) which is in a PON configuration. The passive splitters in a PON are low cost and operate without power. In contrast, an optical P2P network is often in an AON configuration to serve multiple customers, requiring powered switches which can be costly when deployed in the ODN. The P2MP and P2P modules, and the ONTs, generally have both transmitters and receivers, although unidirectional transmission is also possible with only a transmitter on one end of a link and a receiver on the other end of the link.

There are tradeoffs when considering P2MP protocol versus P2P protocol. P2MP may provide reduced network complexity, improved network efficiency, and reduced deployment costs. P2P, however, may provide better reliability and decreased vulnerability to network congestion.

According to principles described herein, a network is designed to utilize both P2MP and P2P technologies. Specifically, the network may be implemented to provide high-speed download capabilities to endpoints in a network using P2P protocol. The endpoints may also be provided with upload connections that use P2MP technologies. The upload connections over the P2MP portion of the network may be managed using various models of time division multiplexing (TDM) as will be described in further detail below.

The configuration herein allows the best use of both P2MP and P2P technologies. The PON ODN uses passive splitters for low cost, with no active elements. The P2MP technology is designed to support multiple users using PON techniques. Most subscribers can get adequate service using the P2MP connections, while one or a few select subscribers get very high speed service using the P2P connection(s).

In one example, a coordination module directs data traffic to traverse either the P2P connection or the P2MP connection and issues other control and management instructions, in particular instructions related to traffic. The traffic can be directed, routed switched or scheduled to perform load balancing, packet splitting, bonding, or fail-over.

P2P technology, such as Ethernet, was originally designed to serve one user. The P2P connection can alternately provide service to multiple users, one way of doing so is to use time-division multiplexing (TDM) or time-division multiple access (TDMA) to assign some time slots to some users. Time-division can be readily configured in the downstream direction by the coordination module or the P2P module to assign time slots to users' traffic. The upstream is more difficult, P2MP technologies have protocols to support sending feedback on upstream traffic from ONUs to OLT, and real-time assignment and announcement of time slots. P2P can provide upstream, however it is not readily re-configured in real-time. P2P can simply assign all upstream to a single user, or upstream from multiple users can use TDM with fixed upstream time slots assigned to each upstream user. The fixed upstream time slots could be varied, but generally only slowly and not in real-time. In this way the P2P module can flexibly provide downstream to multiple users, and also provide upstream from multiple users somewhat less flexibly.

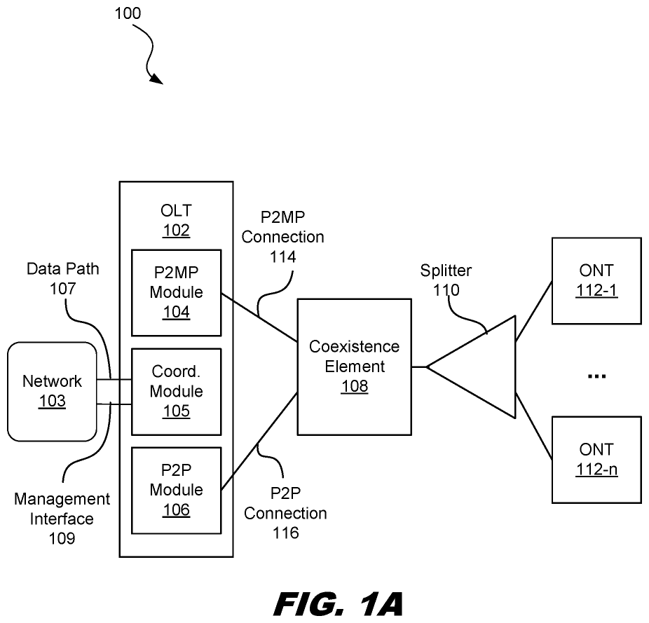

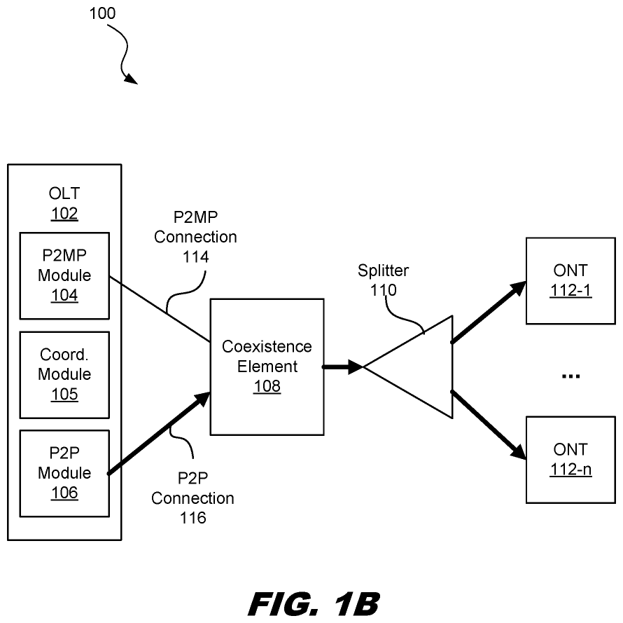

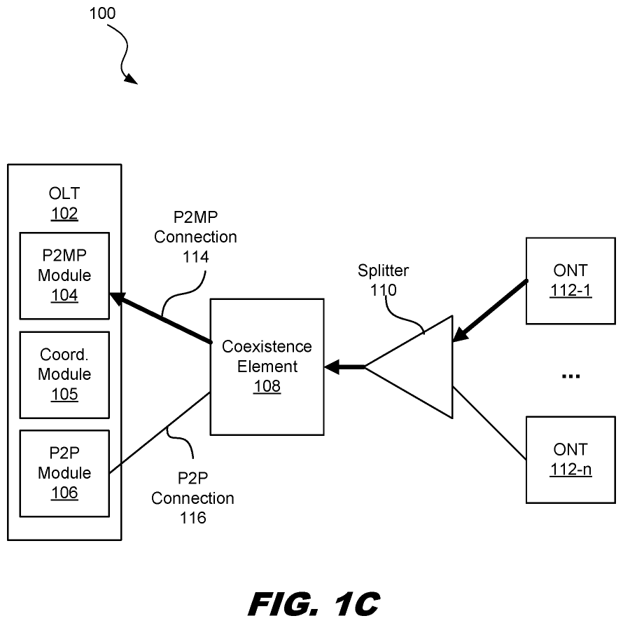

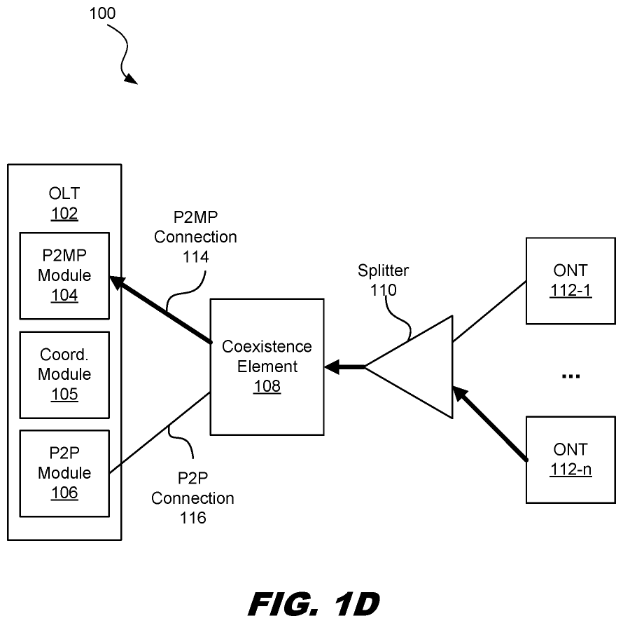

FIG. 1A is a diagram showing an illustrative hybrid point-to-point and point-to-multipoint network 100. According to the present example, the network 100 includes an OLT 102. The OLT 102 includes a P2MP module 104 and a P2P module 106. Both the P2MP module 104 and the P2MP module 106 are connected to a coexistence element 108. The coexistence element 108 connects to a plurality of ONTs 112 through a splitter 110. The connection includes both a data path 107 and a management path 109.

In some examples, the OLT 102 is a device that is used in fiber networks to provide high-speed internet, telephone, and television services to end-users. The OLT 102 may be located at the service provider's central office or headend. The OLT 102 may serve as the central hub of the network. The OLT 102 is responsible for transmitting and receiving data over the fiber-optic cable(s) that connects it to the ONUs or ONTs (e.g., 112) located at the customer's premises.

The OLT 102 may perform a variety of functions. For example, the OLT may aggregate the traffic from multiple ONUs/ONTs and send the traffic to a service provider's backbone network. The OLT 102 may split optical signals into multiple channels, each serving a different customer or group of customers. The OLT 102 may provide network management functions, such as provisioning, monitoring, and maintenance of the optical network. The OLT 102 may also provide security for the network 100 by authenticating and authorizing the ONUs/ONTs, as well as encrypting the data transmitted over the network.

In some examples, the OLT 102 may be implemented as a rack-mounted device such as a line card, that supports multiple types of P2MP protocols. Such P2MP PON protocols may include GPON (Gigabit Passive Optical Network), EPON (Ethernet Passive Optical Network), XG-PON (10 Gigabit Passive Optical Network), XGS-PON (10 Gigabit Symmetrical Passive Optical Network). HSP (High-Speed PON), or VHSP (Very-High Speed PON). The OLT 102 may also support various Quality of Service (QoS) mechanisms, such as bandwidth allocation, to ensure that different types of traffic are given the appropriate priority.

The P2MP module 104 includes the hardware and software to establish and manage P2MP connections over the network between the OLT and ONTs. As explained above, P2MP is a communication protocol used in computer networking to establish a connection between a single sender and multiple receivers. It enables data transmission from one point to multiple destinations simultaneously without the need for multiple point-to-point connections. For example, over the P2MP connection 114, data intended for ONT 112-1 is transmitted to each of the ONTs, ONT 112-1 through ONT-n. Each receiving ONT simply discards data not intended for that ONT and processes the data intended for that ONT. Thus, while ONT 112-1 receives data intended for other ONTs (e.g., ONT 112-n), it will discard such data.

P2P module 106 includes the hardware and software to establish and manage P2P connections over the network 100 between the OLT 102 and ONTs 112. As explained above, a P2P protocol establishes and provides transmission for a single connection from one point to another point. In the present example, a separate P2P connection is established for each ONT. In other words, ONT 112-1 receives only data intended for ONT 112-1 and not for other ONTs (e.g., ONT 112-n), and each of the other ONTs receives its respective data and only its respective data.

The coordination module 105 provides functionality to coordinate between the P2P module and the P2MP module and among the users and applications. Coordination functions can include onboarding, diagnostics and configuration, traffic management and traffic scheduling. The coordination module 105 may have both data path/user plane interfaces 107 and management interfaces 109. Traffic management may be implemented by using the data path interfaces to directly forward traffic to and from the P2P and P2MP modules. Or traffic management may be implemented by the coordination module 105 sending routing or switching instructions over a management interface.

Traffic scheduling and management can include assigning data traffic to traverse either the P2P connection or the P2MP connection. This may be done by assigning a schedule, by assigning ports, by assigning time-slots, or by setting user priorities and assigning QoS flows. For example, high user traffic can use the P2P connection. Different traffic can also be assigned to different ports or ONTs. Moreover, downstream and upstream time slots can be assigned, for example time slots can be sized to match the traffic demanded by each user or paid for by each user. Traffic assignment can match service subscriptions, e.g., to provide the user's service data rate, including committed and excess data rate. Load balancing can attempt to match demand to available transmission capacity. Load balancing can affect each flow, service, or user differently; for example high priority flows can be assigned more capacity. Traffic scheduling can also assign priorities and manage queues. Some capacity can be provisioned ahead of time to support known, upcoming predicted services. Data from the network, for example from a resource allocation function, can be input to assist scheduling by the coordination module.

Traffic can be scheduled directly in the downstream as it comes in from the network and is then sent to the P2P and P2MP modules. Upstream demand can be pre-determined, tracked, forecast, or determined by using data on load, queue occupancy, and traffic demand sent up from the ONTs. Then, upstream time slots or TDM divisions can be assigned using these data.

Traffic can be assigned according to a scheduling algorithm, a load balancing algorithm, or both. Traffic can be assigned to match subscriptions, demand, or anticipated demand. Traffic can be apportioned across P2P and P2MP, per port, per user, per time slot, per packet, per flow, per sub-flow, per service, or per user. A utility function, or fairness criteria can be specified and used by the coordination module to direct traffic apportionment.

Route and time-slot assignment can be based on historical traffic patterns at different time-of-day and day-of-week. Traffic control is valuable for reliability, by assigning traffic to avoid failed or over-used links. Multi-homed load balancing or scheduling can be employed. Multi-homing provides alternative paths in time of severe congestion or equipment failure, and allows increased data rates.

The coexistence element 108 is a network node that is configured to process both P2MP traffic and P2P traffic from both of the modules 104, 106 of the OLT 102. The coexistence element 108 may be, for example, a WDM multiplexing element that separates incoming and outgoing wavelengths, or contain passive splitter ports, or be a combination of a WDM multiplexer and passive splitter ports. Tunable lasers may be employed at the ONT transmitters and then wavelengths can be automatically assigned and run through the WDM or passive splitter. Or, the coexistence element 108 may be an active device such as server or other form of network node. The coexistence element 108 may provide switching or routing functions.

The splitter 110 splits an optical signal received from the coexistence element and transmits a copy to each ONT 112 connected thereto. The splitter 110 may be, for example, a passive optical splitter. A passive optical splitter is a device used in optical networks to split a single optical signal into multiple signals, allowing a single fiber-optic cable to serve multiple users or devices. The splitter is “passive” because it does not require any external power source or active components to operate.

The splitter 110 includes a single input port and multiple output ports, with the number of output ports depending on the design of the splitter. When an optical signal is received at the input port of the splitter, it is split into multiple equal or unequal portions and sent out through the output ports. In the present example, an input port is disposed between the splitter 110 and the coexistence element 108, and each of the ONTs 112 corresponds to a respective output port. The ratio of the split can vary depending on the design of the splitter, with common ratios being 1:4, 1:8, 1:16, and 1:64.

An ONT 112 is a device used in fiber optic networks to connect the fiber-optic cable from the service provider to the customer's premises and provide services such as high-speed internet, telephone, and television services to the end-user. The ONT is typically installed at the customer's location, and it serves as the interface between the fiber-optic cable and the end-user's devices. The ONT receives the optical signal from the service provider's Optical Line Terminal (OLT) and converts the optical signal into electrical signals that can be used by the end-user's devices, such as computers, phones, and televisions.

The ONT 112 performs a variety of functions. The ONT 112 demodulates the signals received from the service provider's network. It may perform routing functions, allowing the end-user to connect multiple devices to the network and share the available bandwidth. The ONT 112 may also provide network management functions, such as monitoring and maintenance of the ONT and the customer's network. In some examples, the ONT 112 ensures the security of the network by authenticating and authorizing the end-user's devices, and encrypting the data transmitted over the network.

The ONT may include multiple ports to allow the connection of multiple devices, such as Ethernet ports for computers, RJ-11 ports for telephones, and RF ports for television. It can also support various protocols, such as Ethernet, GPON, EPON, and XGS-PON.

FIG. 1B is a diagram showing downstream or downlink traffic over the hybrid network 100. According to the present example, The P2P module is configured to provide download traffic to the ONTs through the P2P connection 116. In other words, data intended for ONT 112-1 is transmitted from the P2P module 106 to the coexistence element 108. The coexistence element 108 passes the data to the splitter 110. The splitter 110 then splits the optical signal and passes the transmitted data to each of the ONTs. Each ONT that is not the destination of the transmitted data will then discard that data, while ONT 112-1 may recognize and process the data. To prevent unauthorized snooping, the data may be encrypted.

FIGS. 1C and 1D are diagrams showing upload traffic over the hybrid network 100. According to the present example, during a particular time window, ONT 112-1 transmits data to the coexistence element 108 through the splitter 110. Because each of the ONTs 112-1 to 112-n connected to the splitter 110 share the same optical link between the splitter 108 and the P2MP module 104, a form of multiplexing is used. In this example, a time-division multiplexing (TDM) or a time division multiplex access (TDMA) scheme may be used.

In TDMA, the available bandwidth of the fiber is divided into multiple time slots, and each time slot is allocated to a different data stream. For example, the OLT may divide the available bandwidth of the fiber into multiple time slots and assign each time slot to a different user or data stream. The data from each user or data stream is then transmitted in its assigned time slot. TDMA enables multiple users to share the same fiber-optic cable, without interfering with each other. Each user is allocated a specific time slot, and only transmits data during that time slot, which avoids collisions with other users. A “bandwidth map” can assign TDMA time slots, or sub-slot time allocations within a TDM slot to different users at different times.

Various TDMA models may be used. Using the hybrid network 100, a high-speed upload-as-a-service scheme may be provided. For example, each of the different ONTs 112 may be assigned wide time windows (e.g., 5 pm-6 pm or 2 am-4 am) in which they are granted upload traffic over the P2MP connection 114. This option may be applicable where end users may have large files to upload but may not care specifically when those files are uploaded. In some examples, there may be finer granularity in the time windows. The time windows may have one-minute increments. Even finer time windows that are a few seconds or even a few microseconds or even nanoseconds long may be used as well. Service providers may utilize various models in which customers provide various consideration for different time slots or percentages of available time slots.

FIG. 1D illustrates a different time window than what is shown in FIG. 1C. Specifically, in the time window of FIG. 1D, the upload bandwidth is allocated to ONT 112-n. In some examples, if no time slots are being utilized for upload by the P2MP connection, then the P2MP connection may be assigned to other ONTs or used to supplement download speeds to each of the ONTs 112.

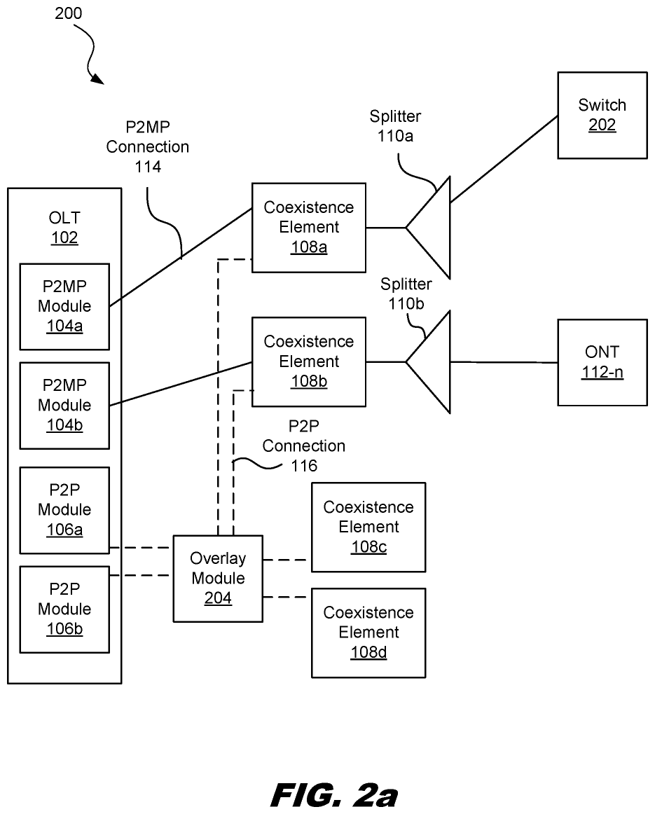

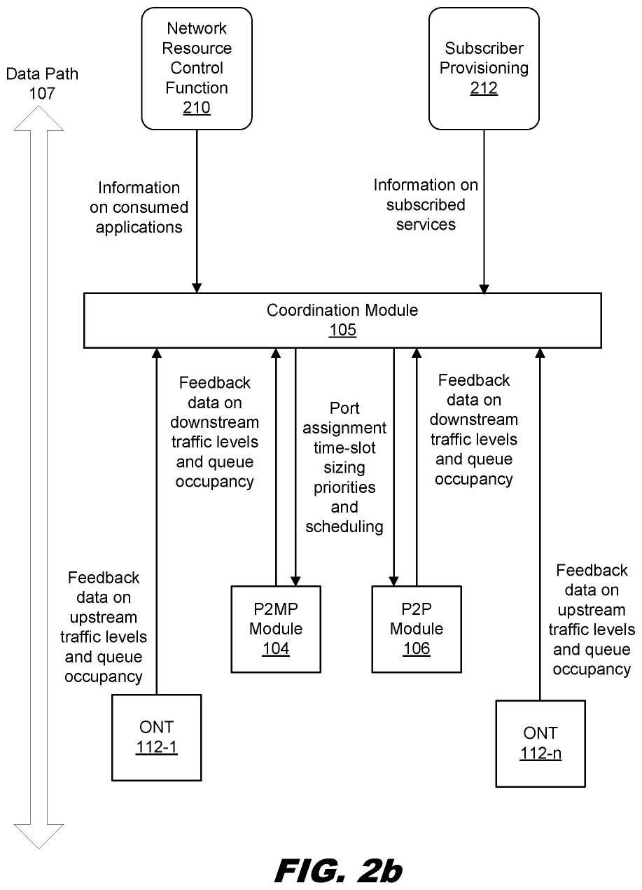

FIG. 2A is a diagram showing additional features of an illustrative hybrid point-to-point and point-to-multipoint network 200. While the network 100 shown in FIGS. 1A-1D illustrates various components, it is understood that a practical implementation of the network may include additional components to provide services to a larger scale of customers. Network 200 shows such additional components as an example, and it is understood that further components may be provided for scale. In some examples, the OLT 102 may include multiple P2MP modules 104a, 104b and multiple P2P modules 106a, 106b. The P2P modules 106a, 106b may utilize an additional overlay module 204 that includes hardware and software for integrating the P2MP and P2P connections. The overlay module 204 may, for example, encrypt download data to prevent snooping. Given that download traffic from the P2P modules will be transmitted through a passive optical splitter and sent to all ONTs connected to a particular splitter, it is desirable to ensure that traffic is encrypted.

The network 200 includes multiple coexistence elements 108a, 108b, 108c, 108d. Coexistence elements 108a, 108b are shown connected to splitters 110a, 110b respectively. Though, other coexistence elements 108c, 108d maybe connected to splitters (not shown) as well. Each splitter may be connected to multiple ONTs 112-n. Some splitters may connect to an ONU that functions as a level 2 switch 202. The switch 202 may pass traffic to additional ONTs or other types of customer premise equipment.

FIG. 2B shows a flowchart implementing scheduling. Here the management interfaces are shown, which send and receive the diagnostics and configuration management data. The data flow is also outlined since the coordination module can directly measure the data flows and direct traffic to and from the P2MP and P2P modules 104, 106. This flow chart can operate both upstream and downstream, however directionality is generally not shown in FIG. 2B.

Data on user subscriptions and services comes into the coordination module from the network resource control function 210, the subscriber provisioning system 212, feedback data on downstream and upstream traffic levels and queue occupancy, and is also indirectly measured from the traffic levels across the data path 107. The coordination module then determines configuration and assignments and issues instructions to control traffic, including port assignment, time-slot sizing, priorities, and scheduling information to the P2MP Module 104 and the P2P module 106. The coordination module can also provide time-slot assignments, bandwidth assignments, wavelength assignments and other data. The P2MP module 104 can send feedback data on downstream traffic levels and queue occupancy up to the coordination module, the P2P module 106 can send feedback data on downstream traffic levels and queue occupancy up to the coordination module, and the ONTs 112-x can send feedback data on upstream traffic levels and queue occupancy up to the coordination module. Additionally, the ONTs, P2MP module, or P2P module can send data on service or application usage or needed capacity up to the coordination module.

Conventional PONs utilize P2MP protocols due to the structure of such networks. Because the network uses passive optical components that split a signal into multiple copies for several destinations, P2MP protocols can provide needed encryption and other functionality. According to principles described herein, the performance of a PON can be improved by creating an overlay of a P2P network over the PON architecture to provide further capabilities at relatively low cost.

The P2MP technology can be as standardized by the ITU-T, including ITU-T specifications G.984.x GPON, G.987.x XG-PON (NG-PON1), G.9807.x XGS-PON, G.989.x NG-PON2, G.9804.x Higher-Speed PON (HSP), G.9802 Multi-Wavelength (MW-PON), G.9806 point-to-point Bi-Directional (BiDi), or G.VHSP Very High Speed PON. Alternately the P2MP technology can be as standardized by the IEEE, including IEEE 802.3ah EPON, IEEE 802.3av 10G-EPON, and IEEE 802.3ca 25G/50G-EPON. The P2MP technology could run across other media.

The P2P connection may be configured to allow only one ONT to transmit upstream. Alternatively, the P2P connection may be configured to assign fixed Time-Division-Multiplexed time slots for multiple ONTs to transmit upstream. Joint scheduling across P2P and P2MP connections can be configured by the coordination module.

The P2P and P2MP connections can include multi-link operation, wherein more than one link is between the OLT and ONT. For example, there may be two P2P connections. In this case, the coordination module can further schedule among the multiple links, e.g., to send more or less traffic across a link in a multi-link group of links.

The P2P connection may only transmit unidirectionally, in the downstream direction only. In this case the P2MP connections can carry upstream data. In this case the upstream can be from each user over their P2MP connection, including the user(s) on the P2P connection, using TDM or TDMA scheduling or wavelength assignment.

The P2P connection and P2MP connections can transmit over multiple wavelengths to use WDM transmission. The coordination module can automatically assign wavelengths among the P2P connection and P2MP connections. WDM can be used to provide “pseudowire” connections that run similar to a P2P with one wavelength per user. Or WDM can provide multiple connections for increasing bandwidth or implementing failover mechanisms. Both WDM and TDMA can be used simultaneously, this can be called Time-Division Wavelength Division Multiplexing (TWDM), and in this case the coordination module can manage, assign, and schedule both wavelength assignments and time slots.

The system can also operate with either the P2P or P2MP connections, or both, using coherent modulation. The system can operate P2P or P2MP connections, or both, using multiple subcarriers. With multiple subcarriers, each user can be assigned to a different subcarrier or group of subcarriers. A group of subcarriers may be shared among multiple users. In this case, the coordination module can manage and control the subcarrier assignments, e.g., to dedicate a single subcarrier to an ONT needing low latency, or to assign numbers of subcarriers to the ONTs according to their data rate demands.

The P2P module can be selectively used to support certain subscribers, or the P2P module can be used to selectively satisfy high-demand, low-latency applications. A subset of P2P time-slots can be assigned to such services.

The coordination module may manage real-time services assignment, on-demand, using “turbo boost.” Here users, applications, or services request high QoS such as extra high speeds or low latency on demand. Then the coordination module assigns additional resources, such as assigning more P2P time-slots to the service.

An ONT may include both a P2P connection and a P2MP connection. The ONT itself may then include its own coordination module, or some of the functionality of the coordination module may be distributed and be in the ONT. Upstream scheduling can involve selection of different traffic to use the P2P or the P2MP connection.

Besides pure optical transport, this system can transmit across other media such as copper telephone lines, coaxial cable, powerlines, wireless, microwaves, radio, powerlines, free-space optics, visible light communications, fixed-wireless access (FWA), cellular, 4G, 5G, or 6G. The P2P connection or the P2MP connection may use media other than fiber optics. Mixed media can be used, for example the P2MP connections can use fiber optics while the P2P connection uses FWA.

The hybrid P2MP and P2P network 200 described herein may be utilized in a variety of ways. For example, the system may receive upstream data over the P2MP connection and transmit downstream data over the P2P connection. In some examples, the system may receive upstream data over the P2MP connection and transmit downstream data over both the P2P and P2MP connections. In some examples, the system may receive upstream data over the P2P and P2MP connections and transmit downstream data over the P2P connection. In some examples, the system may receive upstream data over the P2P and P2MP connections and transmit downstream data over the P2P and P2MP connections.

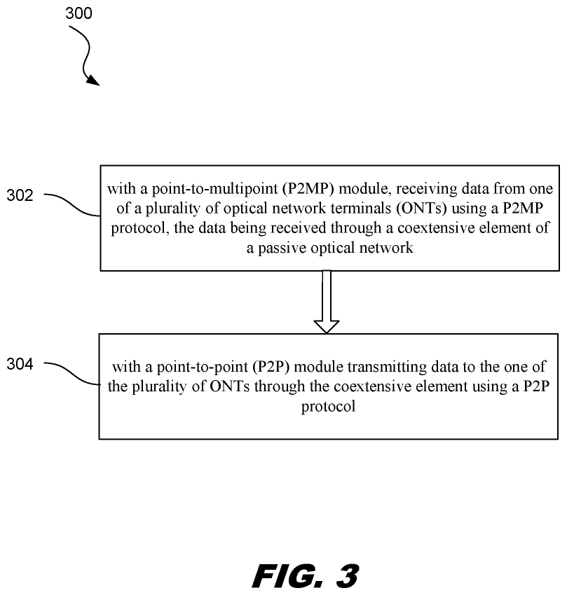

FIG. 3 is a flowchart showing an illustrative method for operating a hybrid point-to-point and point-to-multipoint network. According to one example, a method 300 includes action 302 at which a point-to-multipoint (P2MP) module receives data from one of a plurality of optical network terminals (ONTs) using a P2MP protocol, the data being received through a coexistence element of a passive optical network. For instance, any of the P2MP modules of FIGS. 1-2 may perform action 302. The method 300 further includes action 304 at which a point-to-point (P2P) module transmits data to the one of the plurality of ONTs through the coexistence element using a P2P protocol. For instance, any of the P2P modules of FIGS. 1-2 may perform action 304.

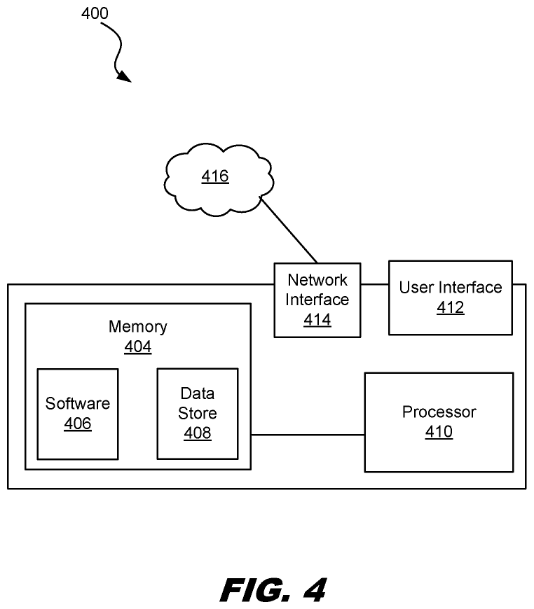

FIG. 4 is a diagram showing an illustrative computing system that may be used to perform processes related to operating a hybrid point-to-point and point-to-multipoint network. The computing system 400 may implement functions of the OLT 102, a coexistence element 108, an ONT 112 or other system described herein. In some examples, the computing system 400 may be implemented as a specially made machine that is specially programed to perform functions relating to thermal management of communication equipment.

The computing system 400 may include a bus (or other communication mechanism) which interconnects subsystems and components for transferring information within the computing system 400. As shown, the computing system 400 includes one or more processors 410, user interface 412, which may include input/output (“I/O”) devices, network interface 414 (e.g., a modem, Ethernet card, or any other interface configured to exchange data with a network), and one or more memories 404 storing pieces of software 406 including, for example, server app(s) and an operating system. The memory may further include a data store, and can communicate with an external database (which, for some examples, may be included within the computing system 400).

The network interface 414 may include optical to electric or electric-to-optical components. For example, the ONT may include an optical-to-electric component to convert the optical signals received from the network 100 into electrical signals for processing. The OLT may include an electric-to-optical component that converts electric signals processed by the OLT to optical signals for traversal over the optical network 100.

The processor 410 may be one or more processing devices configured to perform functions of the disclosed methods, such as a microprocessor manufactured by Intel™ or manufactured by AMD™ or other company. The processor 410 may comprise a single core or multiple core processors executing parallel processes simultaneously. For example, the processor 410 may be a single core processor configured with virtual processing technologies. In certain examples, the processor 410 may use logical processors to simultaneously execute and control multiple processes. The processor 410 may implement virtual machine technologies, or other technologies to provide the ability to execute, control, run, manipulate, store, etc. multiple software processes, applications, programs, etc. In some examples, the processor 410 may include a multiple-core processor arrangement (e.g., dual, quad core, etc.) configured to provide parallel processing functionalities to allow the computing system 400 to execute multiple processes simultaneously. It is appreciated that other types of processor arrangements could be implemented that provide for the capabilities disclosed herein.

The memory 404 may be a volatile or non-volatile, magnetic, semiconductor, tape, optical, removable, non-removable, or other type of storage device or tangible or non-transitory computer-readable medium that stores one or more program(s) such as server apps and an operating system. Common forms of non-transitory media include, for example, a flash drive a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same.

The computing system 400 may include one or more storage devices configured to store information used by processor 410 (or other components) to perform certain functions related to the disclosed examples. For example, the computing system 400 may include memory 404 that includes instructions to enable the processor 810 to execute one or more applications, such as software 406, and any other type of application or software known to be available on computer systems. Alternatively or additionally, the instructions, application programs, etc. may be stored in an external database (which can also be internal to the computing system 400) or external storage communicatively coupled with the computing system 400 (not shown), such as one or more database or memory accessible over the network 408.

The database or other external storage may be a volatile or non-volatile, magnetic, semiconductor, tape, optical, removable, non-removable, or other type of storage device or tangible or non-transitory computer-readable medium. The memory 404 and database may include one or more memory devices that store data and instructions used to perform one or more features of the disclosed examples. The memory 404 and database may also include any combination of one or more databases controlled by memory controller devices (e.g., server(s), etc.) or software, such as document management systems, Microsoft™ SQL databases, SharePoint databases, Oracle™ databases, Sybase™ databases, or other relational databases.

In some examples, the operating system may perform operating system functions when executed by one or more processors such as the processor 410. By way of example, the operating system may include Microsoft Windows™, Unix™, Linux™, Apple™ operating systems, Personal Digital Assistant (PDA) type operating systems, such as Apple iOS™, Google Android™, Blackberry OS™, or other types of operating systems. Accordingly, disclosed examples may operate and function with computer systems running any type of operating system. The computing system 400 may also include software that, when executed by a processor, provides communications with network 416 through the network interface 414 and/or a direct connection to one or more network devices.

In some examples, the data 408 may include, for example, network configurations, system parameters, system conditional data, device parameters, device conditional data, association models, or any other form of data described herein.

The computing system 400 may also include one or more I/O devices having one or more interfaces for receiving signals or input from devices and providing signals or output to one or more devices that allow data to be received and/or transmitted by the computing system 400. For example, the computing system 400 may include interface components for interfacing with one or more input devices, such as one or more keyboards, mouse devices, and the like, that enable the computing system 400 to receive input from an operator or administrator (not shown).

Some examples of processing systems described herein may include non-transitory, tangible, machine readable media that include executable code that when run by one or more processors may cause the one or more processors to perform the processes of methods as described above. Some common forms of machine readable media that may include the processes of methods are, for example, floppy disk, flexible disk, hard disk, magnetic tape, any other magnetic medium, CD-ROM, any other optical medium, RAM, PROM, EPROM, FLASH-EPROM, any other memory chip or cartridge, and/or any other medium from which a processor or computer is adapted to read.

Although illustrative examples have been shown and described, a wide range of modification, change and substitution is contemplated in the foregoing disclosure and in some instances, some features of the examples may be employed without a corresponding use of other features. One of ordinary skill in the art would recognize many variations, alternatives, and modifications. Thus, the scope of the disclosure should be limited only by the following claims, and it is appropriate that the claims be construed broadly and in a manner consistent with the scope of the examples disclosed herein.

What is claimed is:

1. A system for communication over optical fiber comprising:
a point-to-multipoint (P2MP) module configured to provide a P2MP connection to at least one coexistence element of a network; and
a point-to-point (P2P) module configured to provide a P2P connection to a coexistence element;
a coordination module to direct data traffic to traverse either the P2P connection or the P2MP connection;
wherein the system is configured to receive data over the P2MP connection and transmit data over the P2P connection.

2. The system of claim 1, wherein the P2MP module uses a standardized Passive Optical Network (PON) technology.

3. The system of claim 1, wherein the P2P connection uses a standardized optical Ethernet technology.

4. The system of claim 1, wherein only one ONT transmits in the upstream direction across the P2P connection.

5. The system of claim 1, wherein multiple ONTs transmit in the upstream direction across the P2P connection, and each ONT is assigned to transmit in a periodic time slot.

6. The system of claim 1, wherein the coordination module directs data traffic by performing one or more of: load balancing, packet splitting, bonding, and fail-over.

7. The system of claim 1, wherein the coordination module provides traffic scheduling data to the P2MP module and the P2P module.

8. The system of claim 1, wherein the coordination module directing data traffic provides instructions to apportion data traffic across one or more of: per P2P or P2MP connection, per port, per user, per time slot, per packet, per flow, per sub-flow, per service, and per user.

9. The system of claim 1, wherein the P2P module is configured to use an encryption protocol to encrypt traffic transmitted over the P2P connection.

10. The system of claim 1, wherein the coexistence element is configured to be in communication through a splitter to a plurality of optical network terminals (ONTs).

11. The system of claim 1, wherein upstream demand is determined using data on one or more of traffic load, data from a network resource control function, data from a subscriber provisioning system, data on downstream and upstream traffic levels and queue occupancy, data measured from the traffic levels across the data path, data on service or application usage, and data on needed capacity.

12. An optical line terminal (OLT) comprising:
a point-to-multipoint (P2MP) module;
a point-to-point (P2P) module;
a plurality of connections to ONTs;
and a coordination module that directs data traffic to traverse either the P2P connection or the P2MP connection;
wherein the OLT is configured to transmit data to one or more ONTs using through the P2P module using a P2P protocol; and
wherein the OLT is configured to receive data from a plurality of ONTs through the P2MP module using a P2MP protocol.

13. The OLT of claim 10, wherein the P2MP protocol comprises a Passive Optical Network (PON) protocol.

14. The OLT of claim 10, further comprising an overlay module to perform encryption of traffic over the P2P network.

15. The OLT of claim 10, wherein the P2P protocol comprises an Ethernet protocol.

16. The OLT of claim 10, wherein the P2P module is configured to use an encryption protocol to encrypt traffic transmitted over the network.

17. The OLT of claim 10, wherein the P2MP module is configured to allot different time windows to the ONTs for transmission of data from the ONTs to the P2MP module.

18. A method comprising:
with a point-to-multipoint (P2MP) module, receiving data from one of a plurality of optical network terminals (ONTs) using a P2MP protocol, the data being received through a coexistence element of a passive optical network; and
with a point-to-point (P2P) module, transmitting data to the one of the plurality of ONTs through the coexistence element using a P2P protocol.
with a coordination module, directing data traffic to traverse either the P2P module or the P2MP module.

19. The method of claim 18, wherein the P2MP protocol comprises a Passive Optical Network (PON) protocol and the P2P protocol comprises an Ethernet protocol.

20. The method of claim 18, wherein the P2MP module is configured to allot different time windows to the ONTs for transmission of data from the ONTs to the P2MP module.
